(19) United States
(12) Patent Application Publication
(10) Pub. No.: US 2023/0118082 A1
(43) Pub. Date: Apr. 20, 2023

(54) APPARATUS, METHOD AND SYSTEM FOR MATRIX MULTIPLICATION REUSING MULTIPLY ACCUMULATE OPERATION

(71) Applicant: Samsung Electronics Co., Ltd., Suwon-si (KR)

(72) Inventors: Youngsub KO, Suwon-si (KR); Minjun PARK, Osan-si (KR)

(73) Assignee: Samsung Electronics Co., Ltd., Suwon-si (KR)

(21) Appl. No.: 17/967,279

(22) Filed: Oct. 17, 2022

(30) Foreign Application Priority Data
Oct. 19, 2021 (KR) 10-2021-0139115

(51) Int. Cl. G06F 17/16

(52) U.S. Cl. CPC G06F 17/16

(57) ABSTRACT

An apparatus includes a plurality of registers; a decoding circuit configured to decode a first instruction; and an execution circuit configured to identify, based on the decoded first instruction, a mode, a first register in which first matrix data is stored, a second register in which second matrix data is stored, and a third register in which third matrix data is stored, select a column of the first matrix data and a row of the second matrix data based on the mode, and perform a multiply accumulate (MAC) operation based on the selected column of the first matrix data, the selected row of the second matrix data, and the third matrix data.

### CROSS-REFERENCE TO RELATED APPLICATION

This application is based on and claims priority under 35 U.S.C. § 119 to Korean Patent Application No. 10-2021-0139115, filed on Oct. 19, 2021, in the Korean Intellectual Property Office, the disclosure of which is incorporated by reference herein in its entirety.

### BACKGROUND

The inventive concepts relate to matrix multiplication, and more particularly, to an apparatus, a method, and a system for matrix multiplication reusing a multiply accumulate (MAC) operation.

Matrix multiplication may be used in various applications. For example, matrix multiplications may be used in computer vision and/or neural networks and may also be used in a geometry calculation in virtual reality and/or augmented reality. The performance and efficiency of applications may depend on the performance and efficiency of matrix multiplications, and thus a structure and a method for performing a matrix multiplication at a high speed and/or efficiency may be required.

### SUMMARY

The inventive concepts provide an apparatus, a method, and a system exhibiting high performance and high efficiency simultaneously for matrix multiplications.

According to an aspect of the inventive concepts, there is provided an apparatus including a plurality of registers; a decoding circuit configured to decode a first instruction; and an execution circuit configured to identify, based on the decoded first instruction, a mode, a first register, of the plurality of registers, in which first matrix data is stored, a second register, of the plurality of registers, in which second matrix data is stored, and a third register, of the plurality of registers, in which third matrix data is stored, select a column of the first matrix data and a row of the second matrix data based on the mode, and perform a multiply accumulate (MAC) operation based on the selected column of the first matrix data, the selected row of the second matrix data, and the third matrix data.

According to another aspect of the inventive concepts, there is provided a method including decoding, by a decoding circuit, a first instruction; identifying, by an execution circuit and based on the decoded first instructions, a mode, a first register in which first matrix data is stored, a second register in which second matrix data is stored, and a third register in which third matrix data is stored; selecting, by the execution circuit, a column of the first matrix data and a row of the second matrix data based on an identified mode; and performing, by the executing circuit, a multiply accumulate (MAC) operation based on the selected column of the first matrix data, the selected row of the second matrix data, and the third matrix data.

According to another aspect of the inventive concepts, there is provided a non-transitory computer-readable storage medium including instructions executable by a processor, wherein the instructions include a first instruction configured to, when executed by the processor, instructs the processor to perform a matrix multiplication, the matrix multiplication includes decoding the first instruction; identifying, based on the decoded first instructions, a mode, a first register in which first matrix data is stored, a second register in which second matrix data is stored, and a third register in which third matrix data is stored; selecting a column of the first matrix data and a row of the second matrix data based on the identified mode; and performing a multiply accumulate (MAC) operation based on the selected column of first matrix data, the selected row of second matrix data, and the third matrix data.

### BRIEF DESCRIPTION OF THE DRAWINGS

Embodiments of the inventive concepts will be more clearly understood from the following detailed description taken in conjunction with the accompanying drawings in which:

FIG. 1 is a block diagram showing an apparatus according to some example embodiments;

FIGS. 2 and 3 are diagrams showing matrix multiplication according to a comparative example;

FIG. 4 is a block diagram showing an execution circuit according to some example embodiments;

FIGS. 5A to 5D are diagrams showing matrix multiplications according to some example embodiments;

FIGS. 6A and 6B are diagrams showing examples of an instruction according to some example embodiments;

FIGS. 7A and 7B are diagrams showing examples of a pseudo code for matrix multiplication according to some example embodiments;

FIGS. 8A and 8B are block diagrams showing examples of an execution circuit according to some example embodiments;

FIG. 9 is a flowchart of a method for matrix multiplication according to some example embodiments;

FIGS. 10A and 10B are flowcharts showing examples of a method for matrix multiplication according to some example embodiments;

FIG. 11 is a flowchart of a method for matrix multiplication according to some example embodiments;

FIG. 12 is a block diagram showing a system according to some example embodiments; and

FIG. 13 is a block diagram showing a computing system according to some example embodiments.

### DETAILED DESCRIPTION OF THE EMBODIMENTS

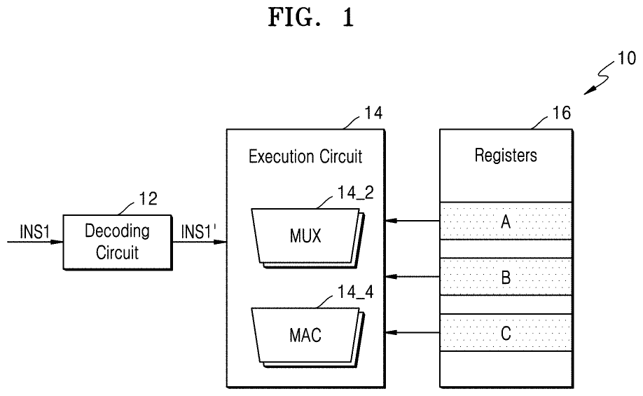

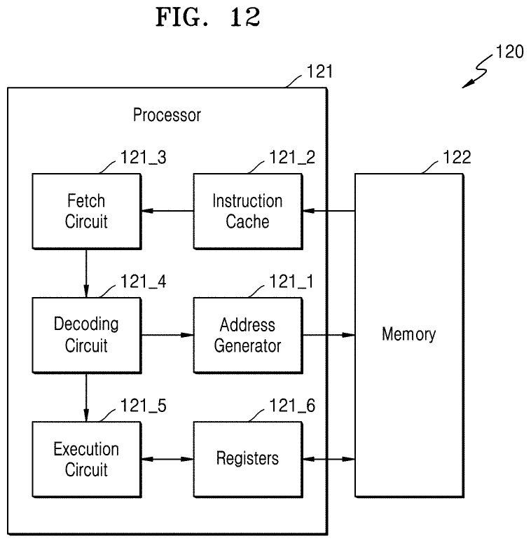

FIG. 1 is a block diagram showing an apparatus 10 according to some example embodiments. In detail, the block diagram of FIG. 1 shows a portion of the apparatus 10 configured to execute instructions. As shown in FIG. 1, the apparatus 10 may include a decoding circuit 12, an execution circuit 14, and a plurality of registers 16. In some embodiments, as described later with reference to FIG. 12, the apparatus 10 may further include additional components for executing instructions other than the components shown in FIG. 1.

The apparatus 10 may refer to any hardware configured to execute instructions. For example, the apparatus 10 may be included in programmable hardware like a central processing unit (CPU), a digital signal processor (DSP), a graphics processing unit (GPU), a neural processing unit (NPU), etc. In some embodiments, the apparatus 10 may be included in an integrated circuit manufactured through a semiconductor process, wherein the decoding circuit 12, the execution circuit 14, and/or the plurality of registers 16 may be integrated with each other (e.g., on one die) or may be respectively integrated on two or more dies. In some embodiments, the apparatus 10 may be referred to as a processor and/or processing circuitry.

The apparatus 10 may execute a first instruction INS1 for matrix multiplication. For example, as shown in FIG. 1, the apparatus 10 may generate a third matrix C by performing at least parts of multiplications of a first matrix A and a second matrix B stored in the registers 16 by executing the first instruction INS1 and store the third matrix C in the registers 16. Herein, an example of generating the third matrix C, which is a 4×4 matrix, by performing multiplications of the first matrix A by the second matrix B, which are 4×4 matrices, will be described, but example embodiments are not limited thereto. For example, example embodiments may also be applied to multiplications of matrices having a dimension lower or higher than 4×4 and may also be applied to multiplications of matrices that are not square matrices (e.g., multiplications of M×N matrices, wherein M and N are integers greater than 0). Herein, a matrix may also be referred to as matrix data.

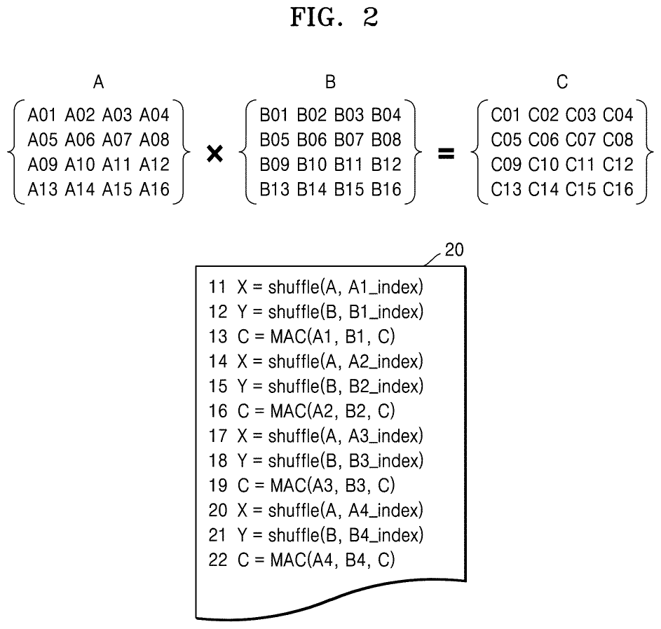

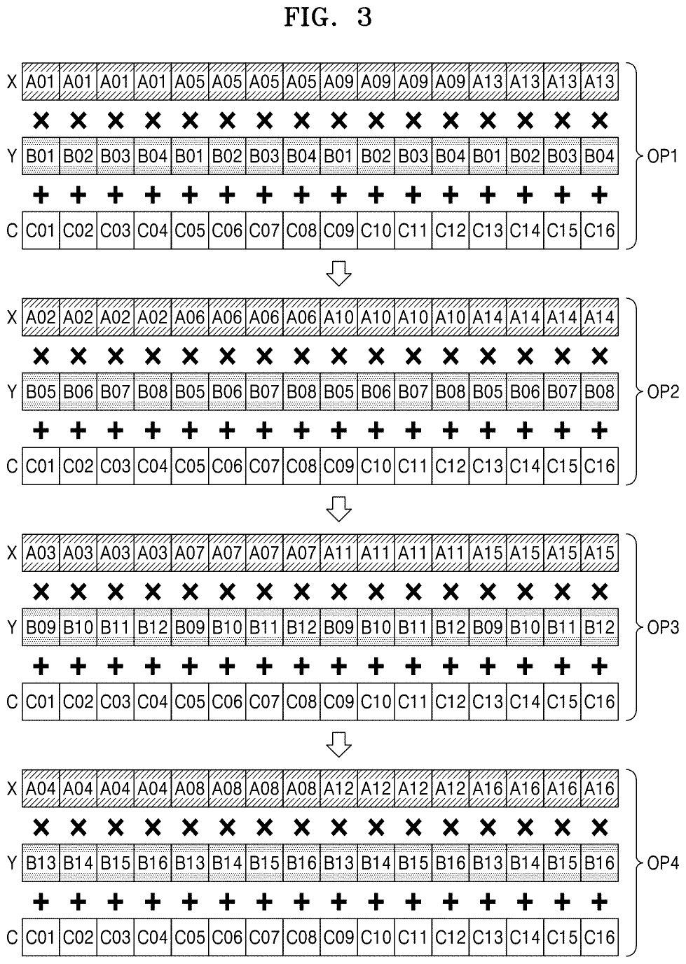

As will be described later with reference to FIG. 2, a matrix multiplication may include a plurality of multiplications between elements included in a matrix, where operands of the multiplications may correspond to elements located at different positions (e.g., indices) in the matrix, respectively. Therefore, a matrix multiplication may include providing appropriate inputs to a multiplier implemented in hardware. As will be described later with reference to FIGS. 2 and 3, when an instruction for rearranging data is used for a matrix multiplication, the time needed for the matrix multiplication may be extended, and resources (e.g., registers) for temporarily storing data may be used.

In a matrix multiplication performed by the apparatus 10 of FIG. 1, hardware for data rearrangement (e.g., 14_2 of FIG. 1) may be combined with hardware for performing multiplication (e.g., 14_4 of FIG. 1). Therefore, execution of an instruction may be omitted, and, as a result, the matrix multiplication may be performed at a high speed. Also, hardware (e.g., 14_4 of FIG. 1) used by other instructions in the apparatus 10 may be shared in a matrix multiplication, and thus increase in a cost (e.g., power consumption and an area) for a high-speed matrix multiplication may be limited. Also, resources (e.g., registers) used for a matrix multiplication in the apparatus 10 may be reduced, and thus the performance of an application, which includes the apparatus 10 or is executed by the apparatus 10, may be improved by registers used for executing other instructions.

The decoding circuit 12 may receive the first instruction INS1 and may generate a decoded first instruction INS1′ by decoding the first instruction INS1. For example, the decoding circuit 12 may extract opcode and/or at least one parameter from the first instruction INS1. In some embodiments, the decoding circuit 12 may extract at least one parameter from the first instruction INS1, based on the value of the opcode extracted from the first instruction INS1. The decoded first instruction INS1′ may include the opcode and/or at least one parameter extracted from the first instruction INS1 and may be provided to the execution circuit 14. As will be described later, the first instruction INS1 may indicate one of a plurality of modes. In some example embodiments, the decoding circuit 12 may decode not only the first instruction INS1, but also instructions included in an instruction set executable by the apparatus 10.

The execution circuit 14 may receive the decoded first instruction INS1′ from the decoding circuit 12, and may perform at least a part of a matrix multiplication based on the decoded first instruction INS1′. For example, the execution circuit 14 may access, among the registers 16, a register storing the first matrix A (which may be referred to herein as a first register), a register storing the second matrix B (which may be referred to herein as a second register), and a register storing the third matrix C (which may be referred to herein as a third register). As shown in FIG. 1, the execution circuit 14 may include a plurality of multiplexers (MUX) 14_2 and a plurality of multiply accumulate (MAC) operators 14_4.

The multiplexers 14_2 may select elements of the first matrix A and elements of the second matrix B according to a mode. For example, the execution circuit 14 may identify a mode based on the decoded first instruction INS1′, and the multiplexers 14_2 may be controlled according to an identified mode. In some embodiments, one of the multiplexers 14_2 may select a column of the first matrix A based on the identified mode, and another one of the multiplexers 14_2 may select a row of the second matrix B based on the identified mode. The multiplexers 14_2 may provide selected elements to the MAC operators 14_4. In some embodiments, the multiplexers 14_2 may be used only in a matrix multiplication. For example, the multiplexers 14_2 may be enabled in response to the first instruction INS1 and may be disabled (and/or bypassed) in response to other instructions.

The MAC operators 14_4 may each receive three inputs and may perform an operation of adding one input to the product of the other two inputs. For example, a MAC operator may add an element of the third matrix C to the product of an element of the first matrix A and an element of the second matrix B selected by the multiplexers 14_2. As such, an operation of accumulating the product of two values may be referred to as a MAC operation. The MAC operators 14_4 may perform MAC operations in parallel with regard to different combinations of elements of the first matrix A, the second matrix B, and the third matrix C, respectively.

The MAC operators 14_4 may respectively perform MAC operations in parallel in response to not only an instruction for a matrix multiplication, e.g., the first instruction INS1, but also other instructions. For example, the decoding circuit 12 may receive and decode an instruction for simultaneously processing multiple data in parallel (e.g., a single instruction multiple data (SIMD) instruction and the MAC operators 14_4 of the execution circuit 14 may perform MAC operations corresponding to a decoded SIMD instruction in parallel). Therefore, the MAC operators 14_4 may be shared by SIMD instructions including the first instruction INS1, and a matrix multiplication may re-use the MAC operators 14_4. As a result, dedicated multipliers and adders for high-speed matrix multiplication may be omitted.

The registers 16 may be accessed by the execution circuit 14 and may store input data and/or output data of operations performed by the execution circuit 14. The registers 16 may have a structure capable of storing data, and the execution circuit 14 may simultaneously access two or more of the registers 16. In some embodiments, the registers 16 may be referred to as register files.

FIGS. 2 and 3 are diagrams showing matrix multiplication according to a comparative example. In detail, FIG. 2 shows a multiplication of the first matrix A by the second matrix B and pseudo code 20 therefor, and FIG. 3 shows elements of the first matrix A, the second matrix B, and the third matrix C that are calculated by the pseudo code 20 of FIG. 2. In FIG. 2, the pseudo code 20 may correspond to assembly code.

Referring to FIG. 2, the first matrix A may include a plurality of elements A01 to A16, the second matrix B may include a plurality of elements B01 to B16, and the third matrix C may include a plurality of elements C01 to C16. The pseudo code 20 may include instructions to rearrange inputs provided to a MAC operator prior to performing a MAC operation. For example, as shown in FIG. 2, the pseudo code 20 may include an instruction (e.g., “shuffle”) for generating inputs of a MAC operation (e.g., X and Y) in which elements of the first matrix A and the second matrix B are rearranged in line 11 and line 12 before an instruction for a MAC operation in line 13 is executed.

Referring to FIG. 3, in a first operation OP1, multiplications between elements A01, A05, A09, and A13 included in a first column of the first matrix A and elements B01 to B04 included in a first row of the second matrix B may be performed, and products thereof may be summed with the elements C01 to C16 of the third matrix C, respectively. For example, the elements A01, A05, A09, and A13 included in the first column of the first matrix A may be stored in a variable (or register) “X” by the “shuffle” in line 11 of FIG. 2, and the elements A01, A05, A09, and A13 may be repeated in the variable “X” as shown in FIG. 3. Also, the elements B01 to B04 included in the first row of the second matrix B may be stored in a variable “Y” by the “shuffle” in line 12 of FIG. 2, and the elements B01 to B04 may be repeated in the variable “Y” as shown in FIG. 3. By “MAC” in line 13, elements of the variable “X”, elements of the variable “Y”, and elements of the third matrix C may be MAC-operated in parallel.

In a second operation OP2, multiplications between elements A02, A06, A10, and A14 included in a second column of the first matrix A and elements B05 to B08 included in a second row of the second matrix B may be performed, and products thereof may be summed with the elements C01 to C16 of the third matrix C, respectively. For example, the elements A02, A06, A10, and A14 included in the second column of the first matrix A may be stored in the variable “X” by the “shuffle” of a line 14 of FIG. 2, and the elements A02, A06, A10, and A14 may be repeated in the variable “X” as shown in FIG. 3. Also, the elements B05 to B08 included in the second row of the second matrix B may be stored in the variable “Y” by the “shuffle” in line 15 of FIG. 2, and the elements B05 to B08 may be repeated in the variable “Y” as shown in FIG. 3. By “MAC” in line 16, elements of the variable “X”, elements of the variable “Y”, and elements of the third matrix C may be MAC-operated in parallel.

In a third operation OP3, multiplications between elements A03, A07, A11, and A15 included in a third column of the first matrix A and elements B09 to B12 included in a third row of the second matrix B may be performed, and products thereof may be summed with the elements C01 to C16 of the third matrix C, respectively. For example, the elements A03, A07, A11, and A15 included in the third column of the first matrix A may be stored in the variable “X” by the “shuffle” of a line 17 of FIG. 2, and the elements A03, A07, A11, and A15 may be repeated in the variable “X” as shown in FIG. 3. Also, the elements B09 to B12 included in the third row of the second matrix B may be stored in the variable “Y” by the “shuffle” in line 18 of FIG. 2, and the elements B09 to B12 may be repeated in the variable “Y” as shown in FIG. 3. By “MAC” in line 19, elements of the variable “X”, elements of the variable “Y”, and elements of the third matrix C may be MAC-operated in parallel.

In a fourth operation OP4, multiplications between elements A04, A08, A12, and A16 included in a fourth column of the first matrix A and elements B13 to B16 included in a fourth row of the second matrix B may be performed, and products thereof may be summed with the elements C01 to C16 of the third matrix C, respectively. For example, the elements A04, A08, A12, and A16 included in the fourth column of the first matrix A may be stored in the variable “X” by the “shuffle” in line 20 of FIG. 2, and the elements A04, A08, A12, and A16 may be repeated in the variable “X” as shown in FIG. 3. Also, the elements B13 to B16 included in the fourth row of the second matrix B may be stored in the variable “Y” by the “shuffle” in line 21 of FIG. 2, and the elements B13 to B16 may be repeated in the variable “Y” as shown in FIG. 3. By “MAC” in line 22, elements of the variable “X”, elements of the variable “Y”, and elements of the third matrix C may be MAC-operated in parallel.

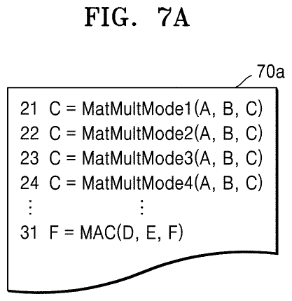

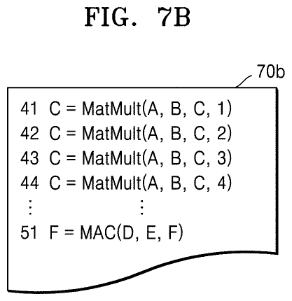

As described above, the pseudo code 20 may include a total of 12 instructions (e.g., 8 “shuffles” and 4 “MACs”) to perform multiplications of 4×4 matrices, and thus the pseudo code 20 may include more instructions than examples described below with reference to FIGS. 7A and 7B. Also, to perform multiplication of 4×4 matrices, the pseudo code 20 may use additional registers (e.g., X and Y) in addition to registers storing the first matrix A and the second matrix B. When 4 “MACs” are successively executed for pipelining MAC operations differently as shown in FIG. 2, 8 registers may be required to prepare inputs for the 4 “MACs” in advance. Therefore, the pseudo code 20 may use more resources than the examples described below with reference to FIGS. 7A and 7B.

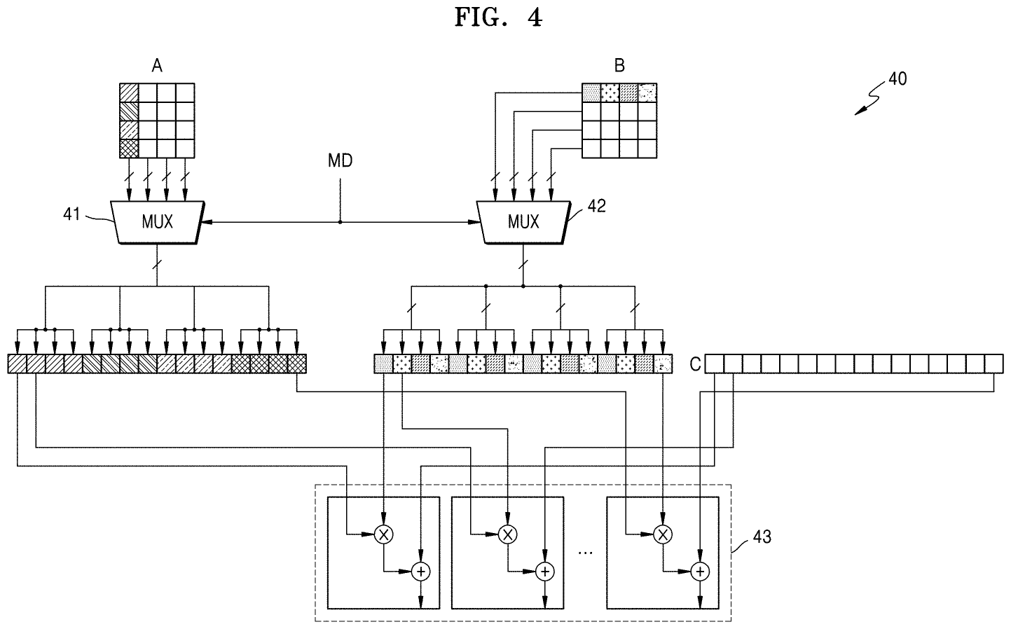

FIG. 4 is a block diagram showing an execution circuit 40 according to some example embodiments. In detail, the block diagram of FIG. 4 shows an example of the operation of the execution circuit 14 of FIG. 1 that performs multiplications of 4×4 matrices. As shown in FIG. 4, the execution circuit 40 may include a first multiplexer 41, a second multiplexer 42, and a plurality of MAC operators 43.

The first multiplexer 41 and the second multiplexer 42 may receive a mode signal MD. In some example embodiments, the mode signal MD may be included in the decoded first instruction INS1′ of FIG. 1, and the mode of the execution circuit 40 may be set according to the mode signal MD. The mode of the execution circuit 40 may determine operands of multiplications performed by the MAC operators 43. For example, the first multiplexer 41 may select one of columns of the first matrix A based on the mode signal MD and may output elements included in a selected column. Also, the second multiplexer 42 may select one of rows of the second matrix B based on the mode signal MD and may output elements included in a selected row.

Each of elements output by the first multiplexer 41 and the second multiplexer 42 may be provided to two or more MAC operators. For example, 4 elements output by the first multiplexer 41 may be repeated as shown in FIGS. 4, and 16 repeated elements may be provided to 16 MAC operators, respectively. Also, 4 elements output by the second multiplexer 42 may be repeated as shown in FIGS. 4, and 16 repeated elements may be provided to 16 MAC operators, respectively.

The MAC operators 43 may each multiply an element output by the first multiplexer 41 by an element output by the second multiplexer 42 and add an element of the third matrix C to a product thereof. As described above with reference to FIG. 1, the MAC operators 43 may be used not only by the first instruction INS1 used for matrix multiplication, but also by other instructions (e.g., SIMD instructions).

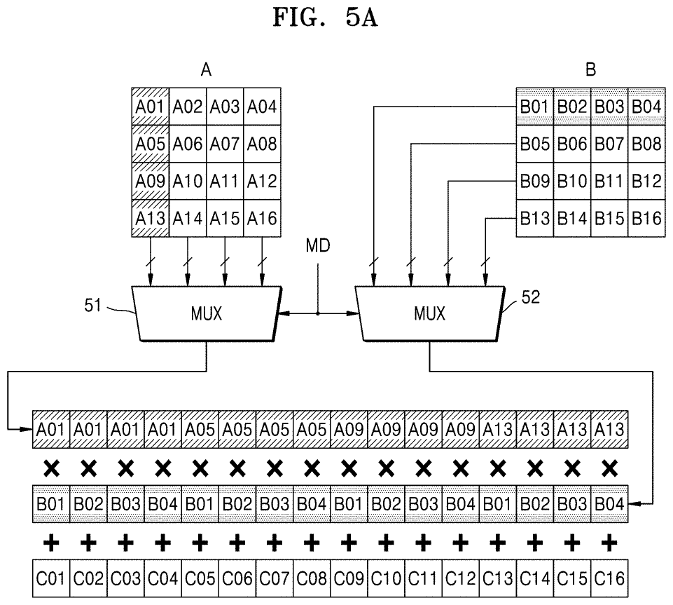

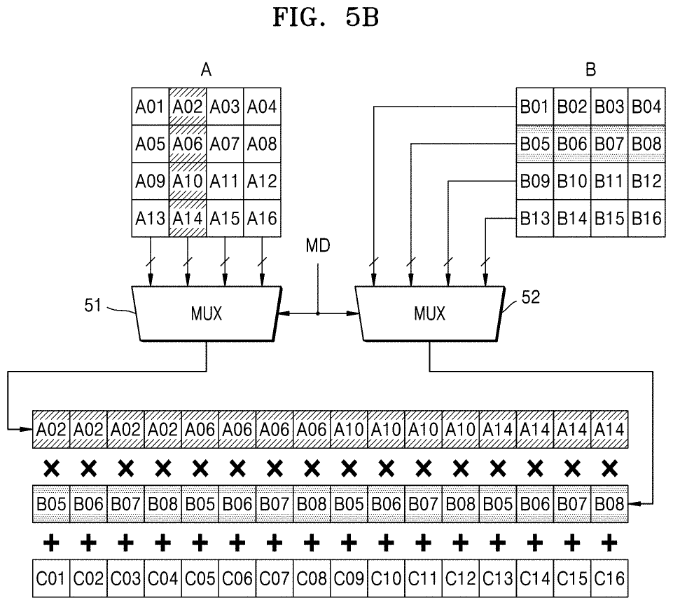

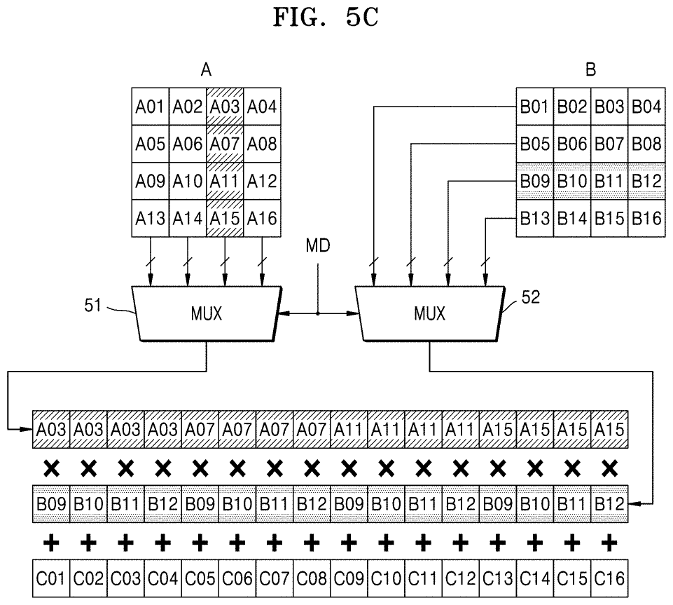

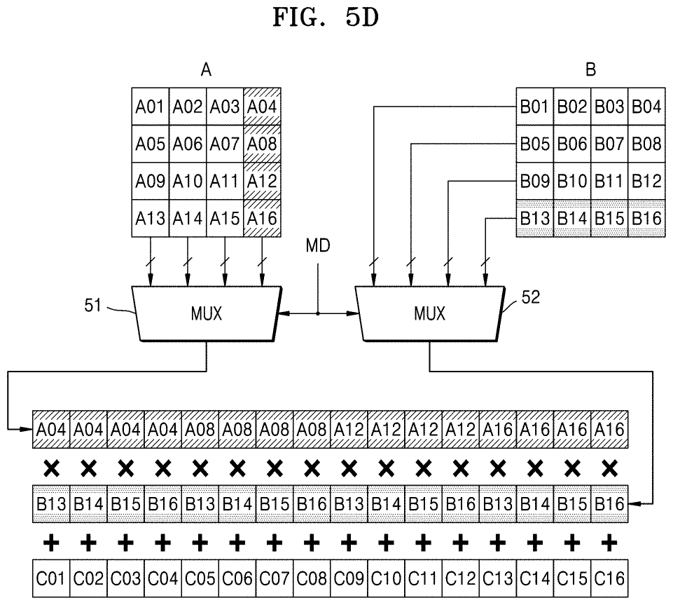

FIGS. 5A to 5D are diagrams showing matrix multiplications according to some example embodiments. In detail, FIGS. 5A to 5D show elements of the first matrix A, the second matrix B, and the third matrix C that are calculated by the execution circuit 40 of FIG. 4.

Referring to FIG. 5A, the mode signal MD may indicate a first mode. In the first mode, a first multiplexer 51 may select the first column of the first matrix A and may output elements A01, A05, A09, and A13 included in the first column. Also, in the first mode, a second multiplexer 52 may select the first row of the second matrix B and may output elements B01, B02, B03, and B04 included in the first row. The elements A01, A05, A09, and A13 output by the first multiplexer 51 and the elements B01, B02, B03, and B04 output by the second multiplexer 52 may be repeated as shown in FIG. 5A and may be MAC-operated with the elements C01 to C16 of the third matrix C.

Referring to FIG. 5B, the mode signal MD may indicate a second mode. In the second mode, the first multiplexer 51 may select the second column of the first matrix A and may output elements A02, A06, A10, and A14 included in the second column Also, in the second mode, the second multiplexer 52 may select the second row of the second matrix B and may output elements B05, B06, B07, and B08 included in the second row. The elements A02, A06, A10, and A14 output by the first multiplexer 51 and the elements B05, B06, B07, and B08 output by the second multiplexer 52 may be repeated as shown in FIG. 5B and may be MAC-operated with the elements C01 to C16 of the third matrix C.

Referring to FIG. 5C, the mode signal MD may indicate a third mode. In the third mode, the first multiplexer 51 may select the third column of the first matrix A and may output elements A03, A07, A11, and A15 included in the third column. Also, in the third mode, the second multiplexer 52 may select the third row of the second matrix B and may output elements B09, B10, B11, and B12 included in the third row. The elements A03, A07, A11, and A15 output by the first multiplexer 51 and the elements B09, B10, B11, and B12 output by the second multiplexer 52 may be repeated as shown in FIG. 5C and may be MAC-operated with the elements C01 to C16 of the third matrix C.

Referring to FIG. 5D, the mode signal MD may indicate a fourth mode. In the fourth mode, the first multiplexer 51 may select the fourth column of the first matrix A and may output elements A04, A08, A12, and A16 included in the fourth column. Also, in the fourth mode, the second multiplexer 52 may select the fourth row of the second matrix B and may output elements B13, B14, B15, and B16 included in the fourth row. The elements A04, A08, A12, and A16 output by the first multiplexer 51 and the elements B13, B14, B15, and B16 output by the second multiplexer 52 may be repeated as shown in FIG. 5D and may be MAC-operated with the elements C01 to C16 of the third matrix C.

As described above with reference to FIGS. 5A to 5D, data may be rearranged with only one instruction instructing execution of a MAC operation by the first multiplexer 51 and the second multiplexer 52. Accordingly, the use of an instruction (e.g., “shuffle” of FIG. 2) for rearranging data and the use of a separate register for storing rearranged data may be omitted.

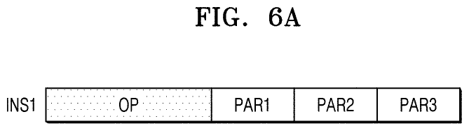

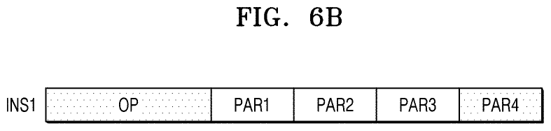

FIGS. 6A and 6B are diagrams showing examples of an instruction according to some example embodiments. In detail, FIGS. 6A and 6B show examples of the first instruction INS1 of FIG. 1 used for a matrix multiplication, respectively. As described above with reference to the drawings, the first instruction INS1 may indicate a mode, and the execution circuit 14 of FIG. 1 may operate differently according to the indicated mode. Hereinafter, FIGS. 6A and 6B will be described with reference to FIG. 1.

Referring to FIG. 6A, the first instruction INS1 may include opcode OP and first to third parameters PAR1 to PAR3. In some embodiments, the first instruction INS1 may include the opcode OP and the first to third parameters PAR1 to PAR3 in different order from that shown in FIG. 6A. The opcode OP may have a value indicating a matrix multiplication. The decoding circuit 12 may identify a matrix multiplication based on the value of the opcode OP extracted from the first instruction INS1 and identify the first to third parameters PAR1 to PAR3 subsequent to the opcode OP. Also, the opcode OP may have a value indicating the mode of a matrix multiplication, and, based on the value of opcode extracted from the first instruction INS1, the decoding circuit 12 may provide a mode signal (e.g., MD of FIG. 4) to the execution circuit 14. Therefore, in the example of FIG. 6A, in the case of a 4×4 matrix multiplication, the opcode OP may have one of four different values, respectively corresponding to four modes.

A first parameter PAR1 may have a value indicating an address (an index or a pointer) of a register (e.g., a first register) in which the first matrix A is stored as an operand of a matrix multiplication. A second parameter PAR2 may have a value indicating an address (an index or a pointer) of a register (e.g., a second register) in which the second matrix B is stored as an operand of a matrix multiplication. A third parameter PAR3 may have a value indicating an address (an index or a pointer) of a register (e.g., a third register) in which the third matrix C is stored as a result of a matrix multiplication. As described above with reference to FIG. 1, the first matrix A, the second matrix B, and the third matrix C may be stored in registers included in the registers 16, respectively, and the first to third parameters PAR1 to PAR3 may indicate the registers in which the first matrix A, the second matrix B, and the third matrix C are stored, respectively. An example of performing a matrix multiplication by using the first instruction INS1 of FIG. 6A will be described later with reference to FIG. 7A.

Referring to FIG. 6B, the first instruction INS1 may include the opcode OP and first to fourth parameters PAR1 to PAR4. In some embodiments, the first instruction INS1 may include the opcode OP and the first to fourth parameters PAR1 to PAR4 in a different order from that shown in FIG. 6B. The opcode OP may have a value indicating a matrix multiplication. The decoding circuit 12 may identify a matrix multiplication based on the value of opcode extracted from the first instruction INS1 and identify the first to fourth parameters PAR1 to PAR4 subsequent to the opcode OP. Unlike the above example of FIG. 6A, in the example of FIG. 6B, the mode of a matrix multiplication may be indicated by a fourth parameter PAR4, which will be described later, rather than opcode OP. Therefore, the first instruction INS1 used in matrix multiplication may include the opcode OP having a constant value. An example of performing a matrix multiplication by using the first instruction INS1 of FIG. 6B will be described later with reference to FIG. 7B.

FIGS. 7A and 7B are diagrams showing examples of pseudocode for matrix multiplication according to some example embodiments. In detail, FIG. 7A shows pseudo code 70a including the first instruction INS1 of FIG. 6A, and FIG. 7B shows pseudo code 70b including the first instruction INS1 of FIG. 6B. The pseudo code 70a and the pseudo code 70b of FIGS. 7A and 7B may correspond to assembly code. Hereinafter, FIGS. 7A and 7B will be described with reference to FIGS. 6A and 6B.

Referring to FIG. 7A, the pseudo code 70a may include instructions representing different modes, respectively. As described above with reference to FIG. 6A, the first instruction INS1 may include the opcode OP indicating a mode, and thus the pseudo code 70a may include four instructions respectively indicating first to fourth modes for multiplications of 4×4 matrices. For example, as shown in FIG. 7A, an instruction “MatMultMode1” in line 21 may indicate a first mode, an instruction “MatMultMode2” in line 22 may indicate a second mode, an instruction “MatMultMode3” in line 23 may indicate a third mode, and an instruction “MatMultMode4” in line 24 may indicate a fourth mode. Also, instructions in lines 21 to 24 may have “A”, “B”, and “C” as values of the first to third parameters PAR1 to PAR3 of FIG. 6A in common. Compared to the pseudo code 20 of FIG. 2, the pseudo code 70a of FIG. 7A may include less instructions and may use less registers.

Referring to FIG. 7B, the pseudo code 70b may include instructions having parameters indicating different modes, respectively. As described above with reference to FIG. 6B, the first instruction INS1 may include the fourth parameter PAR4 indicating a mode, and thus the pseudo code 70b may include four instructions respectively having four values of the fourth parameter PAR4 indicating first to fourth modes for multiplications of 4×4 matrices. For example, as shown in FIG. 7B, an instruction “MatMult” in line 41 may include the fourth parameter PAR4 having the value “1” indicating a first mode, the instruction “MatMult” in line 42 may include the fourth parameter PAR4 having the value “2” indicating a second mode, the instruction “MatMult” in line 43 may include the fourth parameter PAR4 having the value “3” indicating a third mode, and the instruction “MatMult” in line 44 may include the fourth parameter PAR4 having the value “4” indicating a fourth mode. In some embodiments, the four values of the fourth parameter PAR4 indicating the first to fourth modes may be different from those shown in FIG. 7B. Also, instructions in lines 41 to 44 may have “A”, “B”, and “C” as values of the first to third parameters PAR1 to PAR3 of FIG. 6B in common. Therefore, compared to the pseudo code 20 of FIG. 2, the pseudo code 70b of FIG. 7B may include less instructions and may use less registers.

As described above with reference to FIG. 1, MAC operators used for a matrix multiplication may be shared by other instructions (e.g., SIMD instructions). For example, in response to an instruction “MAC” in line 31 of FIG. 7A (which may be referred to as a second instruction herein), an execution circuit may use a plurality of MAC operators used by instructions in lines 21 to 24 to add values of registers indicated by “F” (e.g., vector data) to products of values of registers indicated by “D” (e.g., vector data) and values of registers indicated by “E” (e.g., vector data). Also, in response to an instruction “MAC” of FIG. 7B, the execution circuit may use a plurality of MAC operators used by instructions in lines 41 to 44 to add values of registers indicated by “F” (e.g., vector data) to products of values of registers indicated by “D” (e.g., vector data) and values of registers indicated by “E” (e.g., vector data).

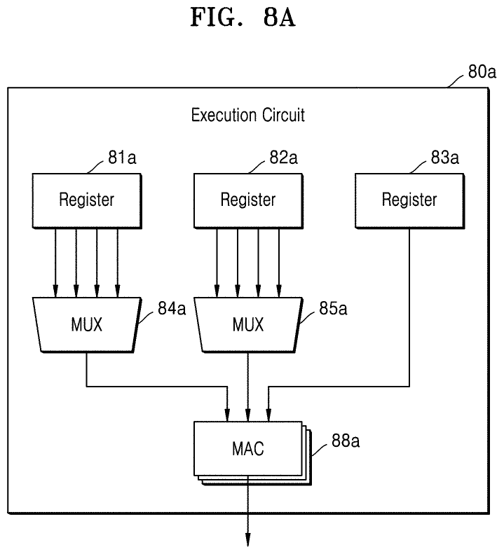

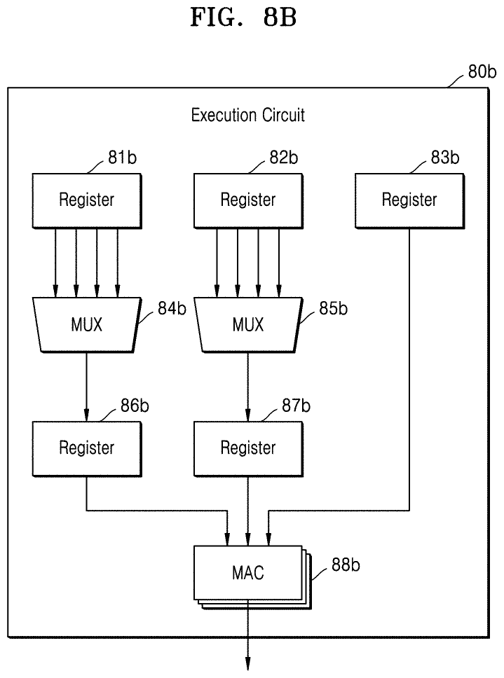

FIGS. 8A and 8B are block diagrams showing examples of an execution circuit according to some example embodiments. As described above with reference to the drawings, execution circuits 80a and 80b of FIGS. 8A and 8B may perform at least a part of a matrix multiplication in response to the first instruction INS1. Descriptions of FIGS. 8A and 8B that are identical to each other will be omitted.

Referring to FIG. 8A, the execution circuit 80a may include first to third input registers 81a to 83a, first and second multiplexers 84a and 85a, and a plurality of MAC operators 88a. The first input register 81a may be connected to the first multiplexer 84a, the second input register 82a may be connected to the second multiplexer 85a, and the third input register 83a may be connected to the MAC operators 88a. The execution circuit 80a may copy operands of a matrix multiplication (e.g., the first matrix A and the second matrix B) to the first input register 81a and the second input register 82a in response to the first instruction INS1. For example, the execution circuit 80a may identify a register for storing the first matrix A and a register for storing the second matrix B based on values of the first parameter PAR1 and the second parameter PAR2 included in the first instruction INS1 and copy the first matrix A and the second matrix B from identified registers to the first input register 81a and the second input register 82a.

The first input register 81a and the first multiplexer 84a may be connected to each other, such that a column of the first matrix A stored in the first input register 81a is selected according to a mode. For example, in multiplications of 4×4 matrices, the first multiplexer 84a may function as a 4:1 multiplexer, and four inputs of the first multiplexer 84a may be connected to the first input register 81a to receive bits corresponding to four columns of the first matrix A, respectively. Similarly, the second input register 82a and the second multiplexer 85a may be connected to each other, such that a row of the second matrix B stored in the second input register 82a is selected according to a mode. For example, in multiplications of 4×4 matrices, the second multiplexer 85a may function as a 4:1 multiplexer, and four inputs of the second multiplexer 85a may be connected to the second input register 82a to receive bits corresponding to four rows of the second matrix B, respectively.

The first multiplexer 84a may be connected to the MAC operators 88a, such that outputs of the first multiplexer 84a (e.g., elements included in a selected column of the first matrix A) are repeated as described above with reference to the drawings. Also, the second multiplexer 85a may be connected to the MAC operators 88a, such that outputs of the second multiplexer 85a (e.g., elements included in a selected row of the second matrix B) are repeated as described above with reference to the drawings.

The execution circuit 80a may copy a result of a matrix multiplication (e.g., the third matrix C) to the third input register 83a. For example, the execution circuit 80a may identify a register storing the third matrix C based on the value of the third parameter PAR3 included in the first instruction INS1 and copy the third matrix C from an identified register to the third input register 83a. The third input register 83a and the MAC operators 88a may be connected to each other, such that the elements of the third matrix C are provided to the MAC operators 88a, respectively.

Referring to FIG. 8B, the execution circuit 80b may include first to third input registers 81b to 83b, first and second multiplexers 84b and 85b, first and second rearrangement registers 86b and 87b, and a plurality of MAC operators 88b. Compared with the execution circuit 80a of FIG. 8A, the execution circuit 80b of FIG. 8B may further include the first and second rearrangement registers 86b and 87b. The first input register 81b may be connected to the first multiplexer 84b, the second input register 82b may be connected to the second multiplexer 85b, and the third input register 83b may be connected to the MAC operators 88b.

The first and second rearrangement registers 86b and 87b may generate inputs for a MAC operation (e.g., by shuffling outputs received from the first and second multiplexers 84b and 85b, respectively). For example, the first multiplexer 84b may be connected to the first rearrangement register 86b, such that outputs of the first multiplexer 84b (e.g., elements included in a selected column of the first matrix A) are repeated as described above with reference to the drawings. The first rearrangement register 86b and the MAC operators 88b may be connected to each other, such that elements stored in the first rearrangement register 86b are provided to the MAC operators 88b, respectively. Also, the second multiplexer 85b may be connected to the second rearrangement register 87b, such that outputs of the second multiplexer 85b (elements included in a selected row of the second matrix B) are repeated as described above with reference to the drawings. The second rearrangement register 87b and the MAC operators 88b may be connected to each other, such that elements stored in the second rearrangement register 87b are provided to the MAC operators 88b, respectively.

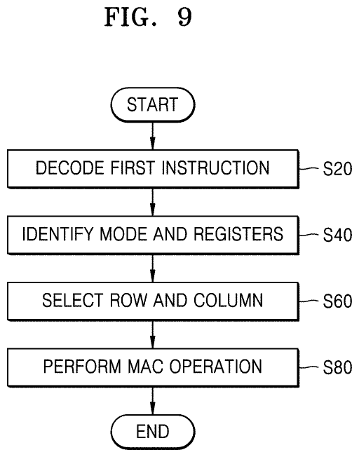

FIG. 9 is a flowchart of a method for matrix multiplication according to some example embodiments. As shown in FIG. 9, the method for matrix multiplication may include a plurality of operations S20, S40, S60, and S80. In some embodiments, the method of FIG. 9 may be performed by the apparatus 10 of FIG. 1. FIG. 9 will be described below with reference to FIG. 1.

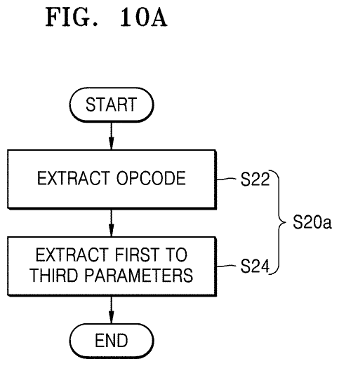

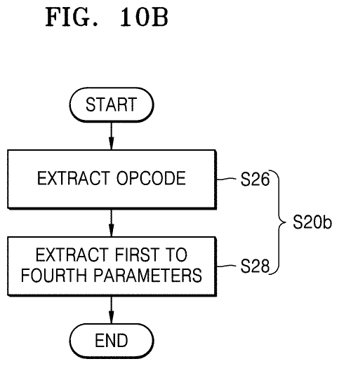

Referring to FIG. 9, the first instruction INS1 may be decoded in operation S20. For example, the decoding circuit 12 may receive the first instruction INS1 and may generate the decoded first instruction INS1′ by decoding the first instruction INS1. The decoding circuit 12 may extract opcode and/or at least one parameter from the first instruction INS1, and the decoded first instruction INS1′ may include the extracted opcode and/or the at least one parameter. Examples of operation S20 will be described later with reference to FIGS. 10A and 10B.

In operation S40, a mode and registers may be identified. For example, the execution circuit 14 may receive the decoded first instruction INS1′ and may identify the mode and registers based on the decoded first instruction INS1′. In some embodiments, as described above with reference to FIG. 6A, the mode may be identified by an opcode included in the first instruction INS1. In some embodiments, as described above with reference to FIG. 6B, the mode may be identified by a value of a parameter (e.g., PAR4 of FIG. 6B) included in the first instruction INS1. Also, the execution circuit 14 may identify registers based on values of parameters included in the decoded first instruction INS1′. For example, the execution circuit 14 may identify registers in which operands of a matrix multiplication are stored and a register in which a result of the matrix multiplication is stored, based on the values of the parameters.

In operation S60, a row and a column may be selected. For example, the multiplexers 14_2 included in the execution circuit 14 may select a column of the first matrix A and a row of the second matrix B according to the mode identified in operation S40. Therefore, data rearrangement may be determined by the mode indicated by the first instruction INS1, and the use of an instruction for data rearrangement may be omitted.

In operation S80, MAC operations may be performed. For example, the MAC operators 14_4 included in the execution circuit 14 may generate products of elements received from the multiplexers 14_2 and sum the products and elements of the third matrix C, respectively. The MAC operators 14_4 may be used not only for the first instruction INS1, but also for other instructions. Therefore, additional multipliers and adders for a matrix multiplication may be omitted.

FIGS. 10A and 10B are flowcharts showing examples of a method for matrix multiplication according to some example embodiments. In detail, FIGS. 10A and 10B show examples of operation S20 of FIG. 9. As described above with reference to FIG. 9, in operation S20a of FIG. 10A and operation S20b of FIG. 10B, the first instruction INS1 may be decoded. Hereinafter, FIGS. 10A and 10B will be described with reference to FIGS. 6A and 6B.

Referring to FIG. 10A, operation S20a may include operations S22 and S24. In some embodiments, as described above with reference to FIG. 6A, the first instruction INS1 may include the opcode OP and the first to third parameters PAR1 to PAR3. Therefore, the opcode OP may be extracted in operation S22, and the first to third parameters PAR1 to PAR3 may be extracted in operation S24. The opcode OP extracted in operation S22 may indicate not only a matrix multiplication, but also the mode of the matrix multiplication, and the decoding circuit 12 may receive and decode four types of the first instruction INS1 respectively having four different opcodes for a multiplication of 4×4 matrices. The first to third parameters PAR1 to PAR3 extracted in operation S24 may indicate locations at which operands of a matrix multiplication are stored and a location at which a result of the matrix multiplication is stored, respectively.

Referring to FIG. 10B, operation S20b may include operations S26 and S28. In some embodiments, as described above with reference to FIG. 6B, the first instruction INS1 may include the opcode OP and the first to fourth parameters PAR1 to PAR4. Therefore, the opcode OP may be extracted in operation S26, and the first to fourth parameters PAR1 to PAR4 may be extracted in operation S28. The opcode OP extracted in operation S26 may indicate a matrix multiplication. The first to third parameters PAR1 to PAR3 extracted in operation S28 may indicate locations at which operands of a matrix multiplication are stored, respectively, and the fourth parameter PAR4 may indicate the mode of the matrix multiplication. Therefore, the decoding circuit 12 may receive and decode four first instructions INS1 having four different values of the fourth parameter PAR4 for a multiplication of 4×4 matrices.

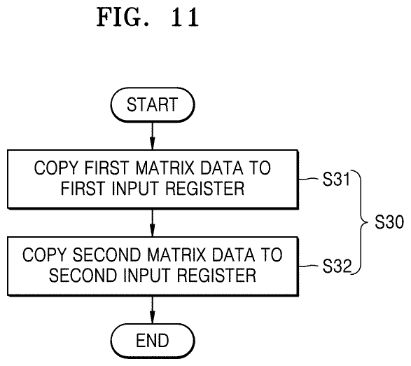

FIG. 11 is a flowchart of a method for matrix multiplication according to some example embodiments. In some embodiments, operation S30 of FIG. 11 may be performed between operations S20 and S40 of FIG. 9. As shown in FIG. 11, operation S30 may include operations S31 and S32. In some embodiments, operation S30 may be performed by the execution circuit 80a of FIG. 8A, and FIG. 11 will be described below with reference to FIG. 8A.

Referring to FIG. 11, first matrix data may be copied to the first input register 81a in operation S31. For example, the execution circuit 80a may identify a register in which the first matrix A is stored based on the first parameter PAR1 included in the first instruction INS1 and copy the first matrix A to the first input register 81a from an identified register.

In operation S32, second matrix data may be copied to the second input register 82a. For example, the execution circuit 80a may identify a register in which the second matrix B is stored based on the second parameter PAR2 included in the first instruction INS1 and copy the second matrix B to the second input register 82a from an identified register.

In some embodiments, operation S30 may be performed only in one of a plurality of modes of a matrix multiplication. For example, as described above with reference to FIGS. 7A and 7B, instructions used for a matrix multiplication may have the same parameters, and thus operations of copying first and second matrix data to the first input register 81a and the second input register 82a may be performed in response to an initial instruction, e.g., an instruction instructing a first mode (e.g., the instruction in line 21 of FIG. 7A or the instruction in line 41 of FIG. 7B).

FIG. 12 is a block diagram showing a system 120 according to some example embodiments. As shown in FIG. 12, the system 120 may include a processor 121 and a memory 122. The processor 121 may perform a matrix multiplication as described above with reference to the drawings.

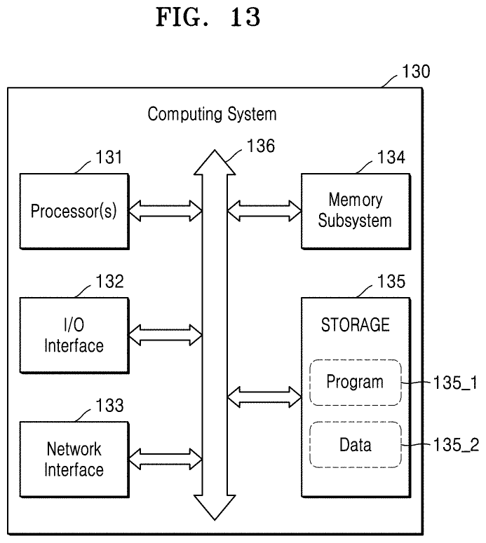

The system 120 may refer to any hardware in which the processor 121 performs a function by executing instructions stored in the memory 122. For example, the system 120 may be a standalone computing system as described below with reference to FIG. 13. Also, the system 120 may be a component included in a higher-level system and may be, for example, a system-on-chip (SoC) in which the processor 121 and the memory 122 are integrated with each other on one chip and/or a module including the processor 121, the memory 122 and a board on which the processor 121 and the memory 122 are mounted.

The processor 121 may communicate with the memory 122, read instructions and/or data stored in the memory 122, and/or write data to the memory 122. As shown in FIG. 12, the processor 121 may include an address generator 121_1, an instruction cache 121_2, a fetch circuit 121_3, a decoding circuit 121_4, an execution circuit 121_5, and a plurality of registers 121_6.

The address generator 121_1 may generate an address for reading an instruction and/or data and may provide the generated address to the memory 122. For example, the address generator 121_1 may receive information, which the decoding circuit 121_4 extracts by decoding an instruction, and may generate an address based on received information.

The instruction cache 121_2 may receive instructions from a region of the memory 122 corresponding to an address generated by the address generator 121_1 and temporarily store received instructions. Since instructions stored in the instruction cache 121_2 in advance are executed, the total time needed to execute instructions may be reduced.

The fetch circuit 121_3 may fetch at least one of instructions stored in the instruction cache 121_2 and provide the fetched instruction to the decoding circuit 121_4. As described above with reference to the drawings, the fetch circuit 121_3 may fetch an instruction for performing at least a part of a matrix multiplication (e.g., the first instruction INS1 of FIG. 1) and provide the first instruction INS1 to the decoding circuit 121_4.

The decoding circuit 121_4 may receive a fetched instruction from the fetch circuit 121_3 and may decode the fetched instruction. For example, the decoding circuit 121_4 may receive the first instruction INS1 from the fetch circuit 121_3 and decode the first instruction INS1. As shown in FIG. 12, the decoding circuit 121_4 may provide information extracted by decoding the fetched instruction (e.g., the decoded first instructions INS1′ of FIG. 1) to the address generator 121_1 and the execution circuit 121_5.

The execution circuit 121_5 may receive a decoded instruction from the decoding circuit 121_4 and may access the registers 121_6. For example, the execution circuit 121_5 may receive the decoded first instruction INS1′ from the decoding circuit 121_4 and, based on the decoded first instruction INS1′, access at least one of the registers 121_6, and perform at least a part of a matrix multiplication. As described above with reference to the drawings, the decoded first instruction INS1′ may indicate one of a plurality of modes, and the execution circuit 121_5 may select data input to MAC operations based on the mode. Therefore, in a matrix multiplication, a separate instruction for data alignment may be omitted, and thus use of additional resources may be eliminated.

The registers 121_6 may be accessed by the execution circuit 121_5. For example, the registers 121_6 may provide data to the execution circuit 121_5 in response to an access of the execution circuit 121_5 and store data provided by the execution circuit 121_5 in response to an access of the execution circuit 121_5. Also, the registers 121_6 may store data read from the memory 122 or store data to be stored in the memory 122. For example, the registers 121_6 may receive data from a region of the memory 122 corresponding to an address generated by the address generator 121_1 and store received data. Also, the registers 121_6 may provide data, which is data to be written to a region of the memory 122 corresponding to an address generated by the address generator 121_1, to the memory 122.

The memory 122 may have a structure for storing instructions and/or data. For example, the memory 122 may include a volatile memory like static random access memory (SRAM) and dynamic random access memory (DRAM) and/or a non-volatile memory like flash memory and resistive random access memory (RRAM).

FIG. 13 is a block diagram showing a computing system 130 according to some example embodiments. In some embodiments, the method for a matrix multiplication, described above with reference to the drawings, may be performed by the computing system 130 of FIG. 13.

The computing system 130 may be a stationary computing system like a desktop computer, a workstation, and/or a server, or may be a portable computing system like a laptop computer. As shown in FIG. 13, the computing system 130 may include at least one processor 131, an input/output (I/O) interface 132, a network interface 133, a memory subsystem 134, a storage 135, and a bus 136; and the at least one the processor 131, the input/output interface 132, the network interface 133, the memory subsystem 134, and the storage 135 may communicate with one another through the bus 136.

The at least one processor 131 may be referred to as at least one processing unit, and may be a programmable processor like a CPU, a GPU, an NPU, and/or a DSP. For example, the at least one processor 131 may access the memory subsystem 134 via the bus 136 and execute instructions stored in the memory subsystem 134. In some embodiments, the computing system 130 may further include an accelerator that is dedicated hardware designed to perform a particular function at a high speed. In some embodiments, the at least one processor 131 may execute the first instruction INS1 described above with reference to the drawings, thereby reducing time and resources needed for a matrix multiplication.

The input/output interface 132 may include, or provide access to an input device (like a keyboard, a touch pad, a microphone, a pointing device, and/or the like) and/or an output device (like a display device, a speaker, a printer, and/or the like). A user may trigger an execution of a program 135_1 and/or a loading of data 135_2 through the input/output interface 132 and may also check a result of the execution of the program 135_1.

The network interface 133 may provide access to a network outside the computing system 130. For example, a network may include a plurality of computing systems and communication links, and the communication links may include wired links, optical links, wireless links, and/or any other types of links.

The memory subsystem 134 may store the program 135_1 (or at least a part thereof) for a matrix multiplication described above with reference to the drawings, and the at least one processor 131 may execute a program (or instructions) stored in the memory subsystem 134 to perform at least some of operations included in the method for a matrix multiplication. The memory subsystem 134 may include read only memory (ROM), random access memory (RAM), etc.

The storage 135 may be a non-transitory computer-readable storage medium such that stored data may not be lost even when power supplied to the computing system 130 is cut off. For example, the storage 135 may include a non-volatile memory device or a storage medium like a magnetic tape, an optical disk, a magnetic disk, and/or the like. In some example embodiments, the storage 135 may be detachable from the computing system 130. As shown in FIG. 13, the storage 135 may store the program 135_1 and the data 135_2.

Before being executed by the at least one processor 131, at least a portion of the program 135_1 may be loaded into the memory subsystem 134. The program 135_1 may include a series of instructions, and the series of instructions may include at least one first instruction INS1 for a matrix multiplication. In some embodiments, the storage 135 may store a file written in a program language, and the program 135_1 generated from the file by a compiler or the like or at least a part of the program 135_1 may be loaded to the memory subsystem 134.

The data 135_2 may include data related to a matrix multiplication. For example, data 135_2 may include operands of a matrix multiplication, e.g., the first matrix A and the second matrix B, and may include a result of the matrix multiplication, e.g., the third matrix C.

In this disclosure, except when expressly indicated otherwise, the functional blocks that denote elements that process (and/or perform) at least one function or operation may be included in and/or implemented as (and/or in) processing circuitry such hardware, software, or the combination of hardware and software. For example, the processing circuitry more specifically may include (and/or be included in), but is not limited to, a processor (and/or processors), Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While the inventive concepts have been particularly shown and described with reference to embodiments thereof, it will be understood that various changes in form and details may be made therein without departing from the spirit and scope of the following claims.

1. An apparatus comprising:
a plurality of registers;
a decoding circuit configured to decode a first instruction; and
an execution circuit configured to
identify, based on the decoded first instruction, a mode, a first register, of the plurality of registers, in which first matrix data is stored, a second register, of the plurality of registers, in which second matrix data is stored, and a third register, of the plurality of registers, in which third matrix data is stored,
select a column of the first matrix data and a row of the second matrix data based on the mode, and
perform a multiply accumulate (MAC) operation based on the selected column of the first matrix data, the selected row of the second matrix data, and the third matrix data.

2. The apparatus of claim 1, wherein the execution circuit comprises:
a first multiplexer configured to output data corresponding to the selected column of the first matrix data based on the mode; and
a second multiplexer configured to output data corresponding to the selected row of the second matrix data based on the mode.

3. The apparatus of claim 2, wherein the execution circuit further comprises:
a first input register connected to inputs of the first multiplexer; and
a second input register connected to inputs of the second multiplexer, and
the execution circuit is configured to copy the first matrix data from the first register to the first input register and copy the second matrix data from the second register to the second input register, based on the decoded first instruction.

4. The apparatus of claim 1, wherein the execution circuit comprises a plurality of MAC operators configured to, respectively, sum an element included in the third matrix data and a product of an element included in the selected column of the first matrix data and an element included in the selected row of the second matrix data.

5. The apparatus of claim 4, wherein
the element included in the selected column of the first matrix data are provided to two or more MAC operators of the plurality of MAC operators,
the element included in the selected row of the second matrix data are provided to two or more MAC operators of the plurality of MAC operators, and
the element included in the third matrix data are provided to one MAC operator of the plurality of MAC operators.

6. The apparatus of claim 1, wherein the decoding circuit is configured to extract, from the first instruction, opcode indicating a matrix multiplication, a first parameter indicating the first register, a second parameter indicating the second register, a third parameter indicating the third register, and a fourth parameter indicating the mode.

7. The apparatus of claim 1, wherein the decoding circuit is configured to extract, from the first instruction, opcode indicating a matrix multiplication and the mode, a first parameter indicating the first register, a second parameter indicating the second register, and a third parameter indicating the third register, from the first instruction.

8. The apparatus of claim 1, wherein
the decoding circuit is further configured to decode a second instruction, and
the execution circuit is configured to identify a fourth register storing first vector data, a fifth register storing second vector data, and a sixth register storing third vector data based on a decoded second instruction and perform a MAC operation based on the first vector data, the second vector data, and the third vector data.

9. A method comprising:
decoding, by a decoding circuit, a first instruction;
identifying, by an execution circuit and based on the decoded first instructions, a mode, a first register in which first matrix data is stored, a second register in which second matrix data is stored, and a third register in which third matrix data is stored;
selecting, by the execution circuit, a column of the first matrix data and a row of the second matrix data based on an identified mode; and
performing, by the executing circuit, a multiply accumulate (MAC) operation based on the selected column of the first matrix data, the selected row of the second matrix data, and the third matrix data.

10. (canceled)

11. The method of claim 9, wherein the execution circuit comprises a plurality of MAC operators,
the performing of the MAC operation comprises summing, by a MAC operator of the plurality of MAC operators, an element included in the third matrix data and a product of an element included in the selected column of the first matrix data and an element included in the selected row of the second matrix data, and
the plurality of MAC operators operate in parallel with respect to elements included in the third matrix data.

12. The method of claim 11, wherein the performing of the MAC operation includes
providing the element included in the selected column of the first matrix data to two or more MAC operators of the plurality of MAC operators,
providing the element included in the selected row of the second matrix data to two or more MAC operators of the plurality of MAC operators, and
providing the element included in the third matrix data to one MAC operator of the plurality of MAC operators.

13. The method of claim 11, further comprising:
decoding, by the decoding circuit, a second instruction; and
performing, by the plurality of MAC operators, a MAC operation based on first vector data, second vector data, and third vector data based on the decoded second instruction.

14. The method of claim 9, wherein the decoding of the first instruction comprises extracting, from the first instruction and by the decoding circuit, opcode indicating a matrix multiplication, a first parameter indicating the first register, a second parameter indicating the second register, a third parameter indicating the third register, and a fourth parameter indicating the mode.

15. The method of claim 9, wherein the decoding of the first instruction comprises extracting, from the first instruction and by the decoding circuit, opcode indicating a matrix multiplication and the mode, a first parameter indicating the first register, a second parameter indicating the second register, and a third parameter indicating the third register.

16. A non-transitory computer-readable storage medium comprising instructions executable by a processor, wherein the instructions comprise a first instruction configured to, when executed by the processor, instructs the processor to perform a matrix multiplication, the matrix multiplication comprising:
decoding the first instruction;
identifying, based on the decoded first instruction, a mode, a first register in which first matrix data is stored, a second register in which second matrix data is stored, and a third register in which third matrix data is stored;
selecting a column of the first matrix data and a row of the second matrix data based on the identified mode; and
performing a multiply accumulate (MAC) operation based on the selected column of the first matrix data, the selected row of the second matrix data, and the third matrix data.

17. The non-transitory computer-readable storage medium of claim 16, wherein the first instruction comprises opcode indicating a matrix multiplication, a first parameter indicating the first register, a second parameter indicating the second register, a third parameter indicating the third register, and a fourth parameter indicating the mode.

18. The non-transitory computer-readable storage medium of claim 17,
wherein the instructions comprise at least one instruction to repeatedly execute the first instruction for same values of the first parameter, same values of the second parameter, same values of the third parameter, and different values of the fourth parameter.

19. The non-transitory computer-readable storage medium of claim 16, wherein the first instruction comprises opcode indicating a matrix multiplication and the mode, a first parameter indicating the first register, a second parameter indicating the second register, and a third parameter indicating the third register.

20. The non-transitory computer-readable storage medium of claim 19, wherein the instructions comprise at least one instruction comprising the first parameter, the second parameter, and the third parameter each having the same value as the first instruction and corresponding to a mode different from the mode of the first instruction.

21. The non-transitory computer-readable storage medium of claim 16, wherein the instructions comprise a second instruction configured to, when executed by the processor, instruct the processor to perform a vector multiplication, and the vector multiplication comprises:
decoding the second instruction; and
performing a MAC operation based on first vector data, second vector data, and third vector data based on the decoded second instruction.
